(19) United States
(12) Patent Application Publication
(10) Pub. No.: US 2018/0178261 A1
(43) Pub. Date: Jun. 28, 2018

(54) Optical Device Window Cleaning System

(71) Applicant: Halliburton Energy Services, Inc, Houston, TX (US)

(72) Inventors: David L. Perkins, The Woodlands, TX (US); Michael T. Pelletier, Houston, TX (US)

(21) Appl. No.: 15/323,786

(22) PCT Filed: Sep. 22, 2015
(86) PCT No.: PCT/US2015/051347

§ 371 Date: Jan. 4, 2017

(51) Int. Cl. B08B 7/02; B08B 3/04

(52) U.S. Cl. CPC B08B 7/02; B08B 3/04

(57) ABSTRACT

A cleaning system provides cleaning of optical device isolation window surfaces without requiring disassembly of the device. The cleaning system utilizes magnetic fields to accumulate abrasive particles on the window. Once accumulated, the cleaning system moves the magnetic fields, thus also moving the accumulated abrasive particles along the surface of the window, thereby cleaning the window. Processing circuitry coupled to the tool may be used to activate and deactivate the cleaning system.

### FIELD OF THE DISCLOSURE

The present disclosure relates generally to optical devices and, more specifically, to the cleaning of optical device isolation windows using magnetic fields.

### BACKGROUND

Many optical systems require that an interface window be used to isolate the sensitive components, such as the radiation source or electronics, from the sample under investigation. For example, in downhole optical systems, sapphire windows are used to allow the transmission of electromagnetic radiation from one side of a fluid transport pipe to the other. In this arrangement, the optical and electronic components are isolated from the high temperature and pressure fluids (i.e., reservoir fluids) by the sapphire interface windows. Interface windows, or isolation windows, also determine how much of the sample to interrogate. For example, in transmission optical arrangements, like those used in some Integrated Computational Element (“ICE”) based optical sensors, two sapphire windows are arranged in parallel separated by 1 millimeter, which is a typical pathlength for monitoring fluids by near infrared (“NIR”) spectroscopic methods.

The composition of some samples can lead to the deposit of components onto the internal surface of the isolation windows, which can result in system measurement errors. Because of the small pathlength used, and the solubility of the deposits, it is difficult to clean the windows with solvents alone. As a result, it may be necessary to disassemble the tool in order to clean the window, which results in costly downtime.

### BRIEF DESCRIPTION OF THE DRAWINGS

FIG. 1 is a block diagram of an optical device having an isolation window cleaning system, according to certain illustrative embodiments of the present disclosure;

FIGS. 2A-2B show a perspective view along line 2A,2B of FIG. 1, in order to illustrate various movement patters of a magnet positioned along a plane parallel to the plane of an isolation window;

FIGS. 2C-2D are perspective views along line 2C,2D of FIG. 1, whereby a magnet is positioned along a plane perpendicular to the plane of an isolation window;

FIG. 3 is a perspective view of the outer surface of an isolation window using a coil assembly to generate a magnetic field, according to certain alternative embodiments of the present disclosure; and

FIGS. 4A and 4B illustrate a plurality of optical devices positioned along a wireline, drill string, and production string extending along a wellbore, according to illustrative applications of the present disclosure.

### DESCRIPTION OF ILLUSTRATIVE EMBODIMENTS

Illustrative embodiments and related methods of the present disclosure are described below as they might be employed in systems and related methods to clean optical system isolation windows. In the interest of clarity, not all features of an actual implementation or method are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. Further aspects and advantages of the various embodiments and related methods of the disclosure will become apparent from consideration of the following description and drawings.

As described herein, illustrative embodiments of the present disclosure are directed to systems and methods to clean optical device isolation windows. More specifically, this disclosures describes methods to clean the inside surface of isolation windows that transmit interrogating electromagnetic radiation to a sample being measured. The embodiments described herein will allow the removal of material from the isolation window's inner surface which may build up over time and degrade the measurement performance of the optical sensor with respect to signal-to-noise, drift, or accuracy.

In a generalized embodiment, an optical device window cleaning system includes at least one isolation window positioned to allow electromagnetic radiation to interrogate a sample, such as, for example, a pipeline or reservoir fluid as it moves past the isolation window. Over time, debris from the sample may accumulate on the isolation window, thus affecting the accuracy of the optical measurements. Therefore, a suspension of abrasive particles is included in the sample and pumped past the isolation window. The cleaning system is configured to generate a magnetic field that causes the abrasive particles in the sample to collect on the internal surface of the isolation window. The system further includes a mechanism to move the magnetic field along the surface of the isolation window, which causes the abrasive particles to scrub the surface, thereby removing any accumulated debris.

Optical devices embodying the window cleaning systems described herein may be utilized in a variety of environments. Such environments may include, for example, downhole well or completion applications. Other environments may include those as diverse as those associated with remote surface (e.g., a pipeline optical sensor window, or an autonomous planetary rover), undersea monitoring (e.g., hydrocarbon production risers, remote controlled submarine rovers), —pipeline monitoring, especially in applications where mechanical wipers or pressurized fluid cleaning mechanisms are not available. Within those environments, the window cleaning systems are utilized to maintain the measurement accuracy of the optical devices as they detect/monitor various sample characteristics, in real time.

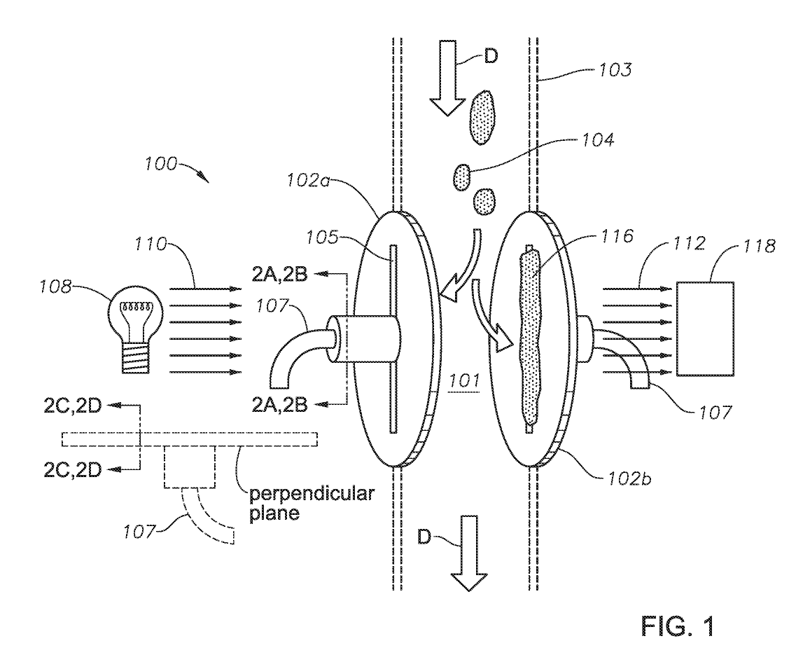

FIG. 1 is a block diagram of an optical device having an isolation window cleaning system, according to certain illustrative embodiments of the present disclosure. Optical device 100 includes an electromagnetic radiation source 108 that is configured to emit or otherwise generate electromagnetic radiation 110. As understood in the art, electromagnetic radiation source 108 may be any device capable of emitting or generating electromagnetic radiation. For example, electromagnetic radiation source 108 may be a light bulb, light emitting device, laser, blackbody, photonic crystal, or X-Ray source, ambient light, etc.

In one embodiment, electromagnetic radiation 110 may be configured to optically interact with a sample (e.g., reservoir fluid flowing through a pipe, wellbore or a portion of a formation) flowing between a first and second isolation window 102a and 102b, respectively, which isolates the optical components from the fluid or sample under study. Isolation windows are transmissive to the electromagnetic radiation emitted by the light source 108 in a wavelength range needed to perform spectroscopic interrogation of the sample. Isolation windows 102a,b may be, for example, sapphire windows. First and second isolation windows 102a,b form a flow area 101 through which a sample (not shown) fluid flows in direction D. The dotted lines in FIG. 1 represent an illustrative flow line 103.

After electromagnetic radiation 110 passes through isolation window 102a, it optically interacts with the sample to generate sample-interacted light 112, which passes through second isolation window 102b. In addition to fluids (liquid or gas), the sample may be slurries, sands, muds, drill cuttings, concrete, etc. In other embodiments, however, the sample may be a multiphase wellbore fluid (comprising oil, gas, water, solids, for example) consisting of a variety of fluid characteristics such as, for example, C1-C4 and higher hydrocarbons, groupings of such elements, and saline water.

The sample may be provided to optical device 100 through a flow line 103 (e.g., a pipe) or a sample cell, for example, containing the sample, whereby it is introduced to electromagnetic radiation 110. While the embodiment of FIG. 1 shows electromagnetic radiation 110 passing through or incident upon the sample to produce sample-interacted light 112 (i.e., transmission), it is also contemplated herein to reflect electromagnetic radiation 110 off of the sample (i.e., reflectance mode), such as in the case of a sample that is translucent, opaque, or solid, and equally generate the sample-interacted light 112. In such an embodiment, only first isolation window 102a will be needed.

Nevertheless, after being illuminated with electromagnetic radiation 110, the sample flowing through area 101 optically interacts therewith to produce an output of electromagnetic radiation (sample-interacted light 112, for example), which is then transmitted through second isolation window 102b. Sample-interacted light 112 thereby contains spectral information that reflects chemical and physical variations of the sample used to determine sample characteristics. Sample-interacted light 112 is then detected by detector 118, which is any device capable of detecting electromagnetic radiation, and may be generally characterized as an optical transducer. For example, detector 118 may be, but is not limited to, a thermal detector such as a thermopile or photoacoustic detector, a semiconductor detector, a piezo-electric detector, charge coupled device detector, or array detector, split detector, photon detector (such as a photomultiplier tube), photodiodes, and/or combinations thereof, or the like, or other detectors known to those ordinarily skilled in the art. In ICE-based systems, detector 118 is further configured to produce an output signal in the form of a voltage or current that corresponds to the particular characteristic of the sample. However, in other systems, such as spectrometers or filter photometers, detector 118 may be coupled to a wavelength dispersive element, and the voltage or current related to the intensity of the optical density (or transmission) is recorded as a function of wavelength.

Ultimately, processing circuitry (not shown) communicably coupled to detector 118 analyzes spectral information of the output signal to determine the sample characteristic. Although not specifically shown, one or more other spectral elements may be employed in optical device 100 in order to restrict the optical wavelengths and/or bandwidths of the system and, thereby, eliminate unwanted electromagnetic radiation existing in wavelength regions that have no importance. Such spectral elements can be located anywhere along the optical train, but are typically employed directly after the light source which provides the initial electromagnetic radiation.

Still referring to the illustrative embodiment of FIG. 1, optical device 100 includes an isolation window cleaning system as described herein. The isolation window cleaning system includes first and second isolation windows 102a,b in this embodiment. However, as previously described, in other embodiments only one isolation window may be utilized. Although the sample fluid flowing through area 101 is not shown for simplicity, a suspension of abrasive particles 104 contained within the sample is shown. Abrasive particles 104 may be magnetic particles or ferrous particles, such as, for example, iron particles, as will be described in more detail below.

As will also be described below, the cleaning system of FIG. 1 generates a magnetic field in a variety of ways in order to collect abrasive particles 104 on the inner surface (also may be referred to as the “first surface”) of isolation windows 102a,b as shown. In this embodiment, a moveable magnet 105, embodied as a magnetic rod, is used to generate the magnetic field to attract abrasive particles 104 toward the inner surface of isolation window 102a,b, where they deposit at location 116 relative to the magnetic field from movable magnet 105. Moveable magnet 105 is coupled to a mechanism 107 which selectively moves/actuates moveable magnet 105 toward the outer surface of isolation windows 102a,b (also referred to as the “second surface”) when needed for the cleaning process. Mechanism 107 may be any variety of suitable mechanisms, such as, for example, solenoid activated mechanisms. Moreover, magnetic rods can be a permanent magnet or an electromagnet. Nevertheless, once mechanism 107 positions moveable magnet 105 on or sufficiently adjacent to the outer surface of isolation windows 102a,b, the magnetic field produced will force abrasive particles 104 to collect on the inner surfaces of windows 102a,b, as shown at 116.

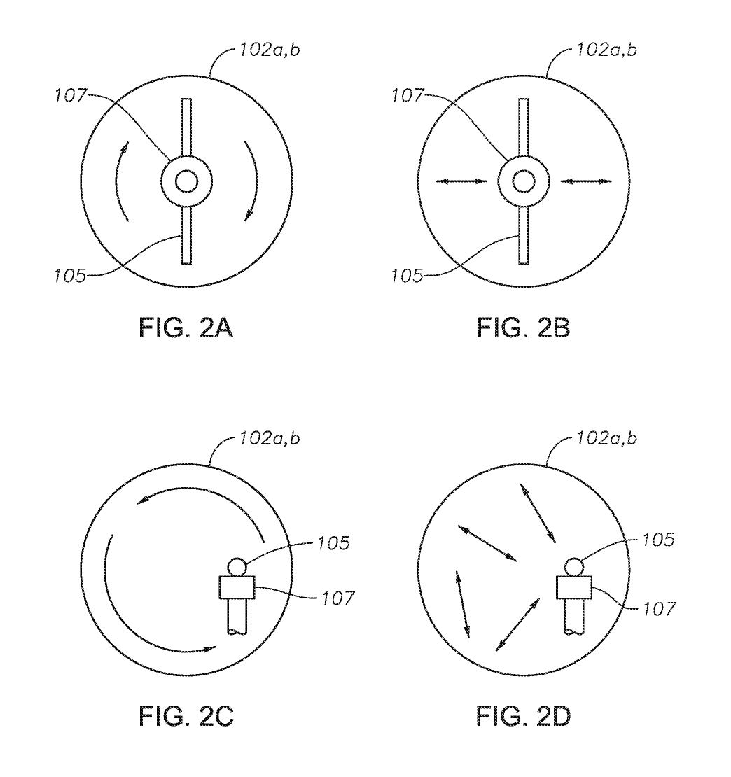

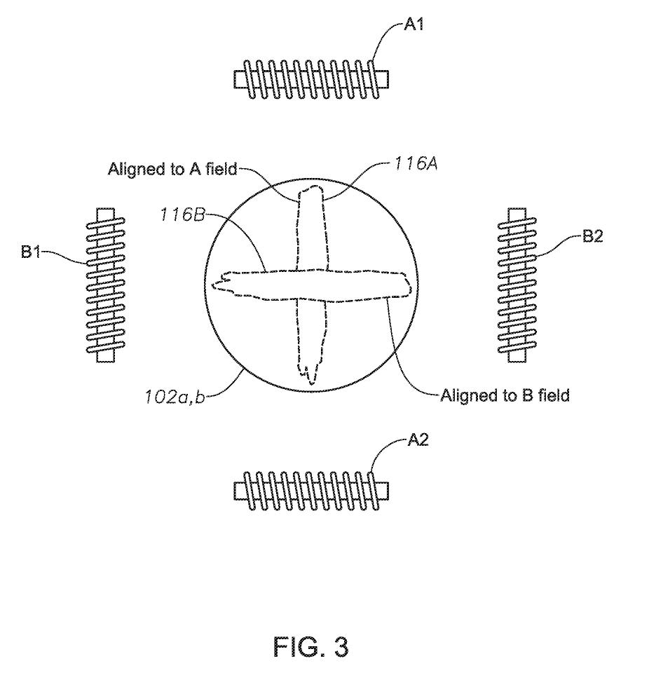

Mechanism 107 may then move magnet 105 along the outer surface of isolation windows 102a,b, thereby causing the collected abrasive particles 116 to scour along the inner surface and clean the windows. FIGS. 2A-2B show a perspective view along line 2A,2B of FIG. 1 in order to illustrate various movement patters of magnet 105. In FIG. 2A, mechanism 107 is shown moving magnet 105 in a rotational pattern around the outer surface of isolation windows 102a,b, while FIG. 2B shows mechanism 107 moving magnet 105 is a back and forth motion, or oscillating it, along the outer surface. Alternatively, magnet 105 may be moved in a random walk (or Brownian motion) type of movement. Nevertheless, as a result of the movement of magnet 105, the accompanying magnetic field is also moved, thereby resulting in the movement of the collected abrasive particles 116. Although not shown, mechanism 107 is communicably coupled to processing circuitry whereby any variety of movement patterns may be selected or programmed in order to produce optimal cleaning of the inner surface of isolation windows 102a,b.

Referring back to FIG. 1, in the description above, abrasive particles 104 are ferrous particles and moveable magnet 105 is used to generate the magnetic field. However, in other embodiments, this arrangement may be reversed whereby abrasive particles 104 are magnetic, while the rod (represented by 105) is made of ferrous material.

During an illustrative operation of optical device 100, electromagnetic radiation source 108 directs radiation 110 toward the two isolation windows 102a,b. The light interacts with the sample in flow area 101, whereby sample-interacted light 112 is transmitted to and detected by optical transducer 118. Over time, however, debris from the sample fluid flowing through area 101 results in sample debris being collected on the inner surface of isolation windows 102a,b. Therefore, when it is desired to clean isolation windows 102a,b, the suspension of abrasive particles 104 is pumped through the system. Abrasive particles 104 may be mixed into other system fluids or may be pumped alone. Nevertheless, before or during pumping, mechanism 107 is actuated to move magnet 105 toward the outer surface of first and second isolation windows 102a,b, whereby magnet 105 produces a magnetic field. In response to the magnetic field, abrasive particles 104 are concentrated on the inner surfaces of windows 102a,b at 116.

In certain illustrative cleaning evolutions of the present disclosure, electromagnetic source 108 is de-energized and mechanism 107 positions magnetic rods 105 against the outer surface of isolation windows 102a,b. As described above in relation to FIGS. 2A-2B, mechanism 107 can be configured to rotate magnetic rod 105 in the plane defined by the sapphire window (parallel plane), or a plane perpendicular to the window (as shown by the dotted lines in FIG. 1 representing rod 105). FIGS. 2C-2D are perspective views along line 2C,2D of FIG. 1, whereby magnet 105 is positioned along a plane perpendicular to windows 102a,b. FIG. 2C shows how magnet 105 is moved in a rotational pattern, while FIG. 2D shows how magnet 105 is moved in a variety of up-down and diagonal patterns. The advantage to using the perpendicular plane is that the magnetic field is strongest at the point at which magnet 105 touches (or is closest too) the outer surface of isolation windows 102a,b. At times, a stronger magnetic field may be necessary to sufficiently clean the windows. FIGS. 2A-2B are illustrative movement patterns, as there are a variety of other patterns which may be utilized.

Referring back to FIG. 1, as the suspension of abrasive particles 104 passes the internal surfaces of the isolation windows 102a,b, abrasive particles 104 are drawn to and assemble onto the internal surfaces of windows 102a,b (identified at 116) by the generated magnetic field. Once there is a sufficient number of abrasive particles 104 on isolation windows 102a,b at 116, magnet 105 is rotated, for example, in an axis perpendicular or parallel to the outer surface of isolation windows 102a,b. The movement of magnet 105 moves the assembled abrasive particles 116 to sweep and scour the internal surface of isolation windows 102a,b. When cleaning is completed, moveable magnets 105 are returned to the standby position (away from windows 102a,b, for example) which results in the abrasive particles returning to the bulk fluid to be completely removed by flushing.

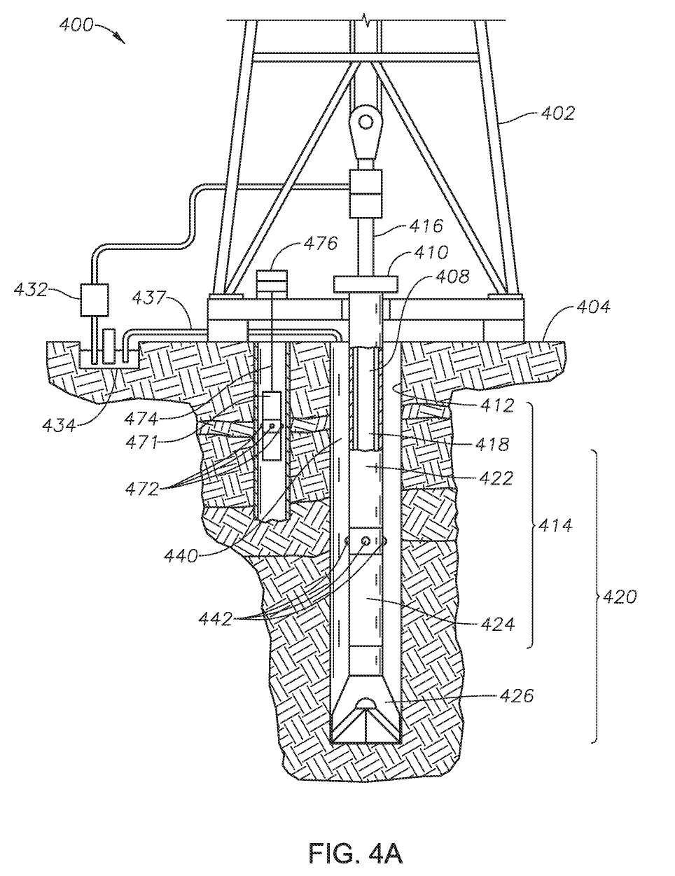

FIG. 3 is a perspective view of the outer surface of an isolation window, according to certain alternative embodiments of the present disclosure. The view of FIG. 3 is somewhat similar to that of FIGS. 2A-2D previously described herein and, therefore, may be best understood with reference thereto, where like numerals indicate like elements. Here, however, instead of magnet or ferrous member 105 being used, a magnetic coil assembly is utilized to generate the magnetic field. As shown, a magnetic coil assembly is positioned adjacent to the outer surface of isolation windows 102,a,b such that it is protected from the fluid flowing along the inner surface of windows 102a,b. Alternatively, however, the magnetic coil assembly may be embedded within isolation windows 102a,b.

Nevertheless, in this example, the magnetic coil assembly includes separate coils, communicably coupled as two pairs of opposing electromagnetic coils A1,A2 and B1,B2. In this example, four electromagnetic coils A1-B2 are positioned at a 90° orientation with respect to its adjacent coil. However, other orientations may be utilized. Also, abrasive particle deposits 116 are shown aligned to the A and B magnetic fields (i.e., those fields produced by activation of its respective coils). Since coils A1-B2 produce the magnetic fields, the abrasive particles are ferrous in nature. Also, coils A1-B2 may be oriented with respect to isolation windows 102a,b in a variety of ways. For example, the coils may be oriented such that their strongest magnetic fields (at the tip of the coil) is closets to the windows.

Although not shown, magnetic coils A1-B2 are communicably coupled to processing circuitry, which selectively controls their activation to thereby energize and manipulate the resulting magnetic fields. During an illustrative cleaning operation, the processing circuitry may activate coils A1 and A2 in order to orient deposited abrasive particles 116A to the magnetic field of coils A1,A2. Thereafter, the processing circuitry may deactivate coils A1,A2 and activate coils B1,B2, thus causing the deposited abrasive particles 116A to rotate to the position of abrasive particles 116B. The processing circuitry may then deactivate coils B1,B2, then reactivate coils A1,A2 in order to rotate the magnetic field and particles accordingly. By doing so, the deposited particles 116 are forced to rotate along the inner surface of the isolation windows 102a,b.

In alternative embodiments, the processing circuitry may be programmed to selectively activate the coils at a high frequency, in a non-sequential fashion such that the deposited abrasive particles 116 jump around the inner surface of isolation window 102a,b, thus cleaning it. Any variety of coil arrangement, activation sequences, frequencies, etc., may be implemented.

In certain methods of the present disclosure, the cleanliness of the isolation windows may be determined using measurement data of the optical device. In one method, the determination of cleanliness of the isolation windows is accomplished by first collecting optical data (e.g., detector voltage, detector signal amplitude, optical spectrum data, etc.) on a reference fluid prior to using the optical device in order to establish a baseline. During operation, the optical data is continuously monitored over time by processing circuitry. However, once the isolation window(s) begin to accumulate debris, a decreasing optical transducer voltage or a shift in spectral data, for example, may be utilized to indicate window fouling or scale build up.

In an alternate method, optical spectra data may be used to indicate the type of fouling (e.g., organic or inorganic). By monitoring a neural density (“ND”) channel in an ICE based system (the normalization channel or “B” channel), the ND signal would decrease as a function of buildup over time. If the detection system is a spectrometer arrangement, the fouling would introduce different absorptions than that of the reference fluid. In a photometer, certain channels can be used to monitor the baseline (i.e., little to no absorption). When fouling occurs, the baseline might increase which would be detected by some or all of these baseline channels. If the fouling is from like substances as that of the reference fluid, some of the absorption peaks that are common to both would increase, thus indicating fouling from like substances. Through the use of such a method, the processing circuitry can monitor the measurement data to determine when the magnetic field of the window cleaning system is to be activated. In addition, the processing circuitry can continue to monitor the measurement data during cleaning in order to determine when to deactivate the magnetic field (which deactivates the cleaning system), which may be indicated, for example, when the voltage or optical spectra signal returned to the baseline.

In yet another illustrative embodiment, if magnetic abrasive particles are utilized, the optical window cleaning system may de-magnetize the particles after cleaning. In certain applications, such as downhole applications, some of the downhole tools (e.g., nuclear magnetic resonance tools, densitometers, etc.) may be comprised of ferrous components which will accumulate the magnetic abrasive particles. In order to avoid this accumulation and its detrimental effect on the components, the optical cleaning system may be configured to de-magnetize the particles after cleaning. For example, in those cleaning system utilizing a coil assembly to produce the magnetic fields, processing circuitry may manipulate the direction of the magnetic fields faster than the abrasive particles can shift polarity, thus heating the abrasive particles. When this heat exceeds the Curie Point, the magnetic particles become demagnetized.

In yet another illustrative method, processing circuitry may determine whether there are a sufficient number of abrasive particles on the internal surfaces of the isolation windows. This may be accomplished by monitoring the fluid leaving the optical device. For example, in one method, a separate optical sensor can be used to measure the transmission optical density (OD) of the fluid exiting the device (which still contains the abrasive particles). After activation of the cleaning system, as the abrasive particles deposit onto the interior surface of the isolation windows, the presence of the particles in the fluid exiting the device will decrease, thus decreasing the OD. The processing circuitry will monitor the output signals of the separate sensor to determine when a sufficient decrease in OD has been reached. This determination may be made by comparing the measured OD with a predetermined OD value. Alternatively, other sensing techniques could also be used, including, for example, a separate magnetic sensor (in embodiments using magnetic abrasive particles).

In certain illustrative embodiments of the present disclosure, the abrasive particles are very small ferrous particles (e.g., atomized Fe powders) which can be delivered to the internal surface of isolation windows 102a,b as a dilute suspension in a suitable liquid solution. The solution can be comprised of, for example, cleaning solvents or water. In another embodiment used in a downhole application, since most downhole tools are fabricated by non-magnetic materials, the abrasive particles can be magnetic particles (e.g., Fe304), and rods 105 can be made of iron, effectively reversing the functionality of these two components.

In yet other illustrative embodiments, layered magnetic nanoparticles (e.g., alternating layers of Fe304 and Si02) may be used as the abrasive particles. The layered magnetic nanoparticles are fabricated to prevent the particles from aggregating or clumping in the suspension fluid. Such an embodiment is especially useful for isolation windows that are made of Si02, or other windows where the cleaning particle is harder than the window. This embodiment is also useful for protecting the magnetic particle with a protective Si02 layer because certain particles, such as nanoparticles, may be chemically destroyed before reaching the window. In certain other embodiments, jewelers rouge (a blend of colloidal iron oxides in a carrier used for buffing & polishing) could be used as the abrasive particles.

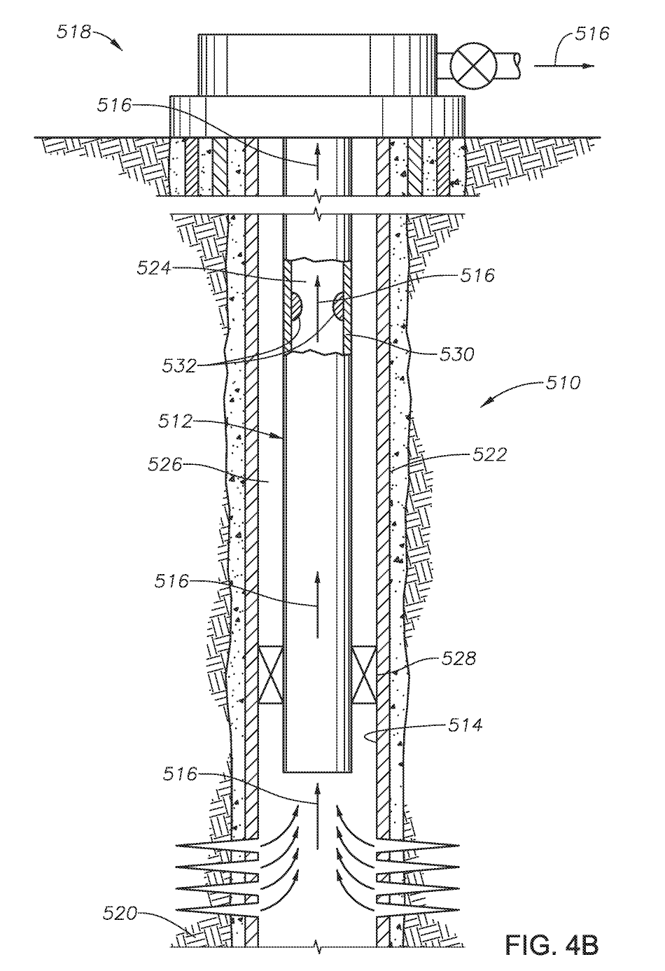

Now that the fundamental theory of the present disclosure has been described, an illustrative application will now be described. Although the optical devices described herein may be utilized in a variety of environments, the following description will focus on downhole well applications. FIG. 4A illustrates a system 400 (also referred to herein as a reservoir interrogation system), according to an illustrative embodiment of the present disclosure. It should be noted that the system 400 can also include a system for pumping or other operations. System 400 includes a drilling rig 402 located at a surface 404 of a wellbore. Drilling rig 402 provides support for a downhole apparatus, including a drill string 408. Drill string 408 penetrates a rotary table 410 for drilling a borehole/wellbore 412 through subsurface formations 414. Drill string 408 includes a Kelly 416 (in the upper portion), a drill pipe 418 and a bottomhole assembly 420 (located at the lower portion of drill pipe 418). In certain illustrative embodiments, bottomhole assembly 420 may include drill collars 422, a downhole tool 424 and a drill bit 426. Downhole tool 424 may be any of a number of different types of tools including, for example, measurement-while-drilling (“MWD”) tools, logging-while-drilling (“LWD”) tools, etc.

During drilling operations, drill string 408 (including Kelly 416, drill pipe 418 and bottom hole assembly 420) may be rotated by rotary table 410. In addition or alternative to such rotation, bottom hole assembly 420 may also be rotated by a motor that is downhole. Drill collars 422 may be used to add weight to drill bit 426. Drill collars 422 also optionally stiffen bottom hole assembly 420 allowing it to transfer the weight to drill bit 426. The weight provided by drill collars 422 also assists drill bit 626 in the penetration of surface 604 and subsurface formations 414.

During drilling operations, a mud pump 432 optionally pumps drilling fluid (e.g., drilling mud), from a mud pit 434 through a hose 436, into drill pipe 418, and down to drill bit 426. The drilling fluid can flow out from drill bit 426 and return back to the surface through an annular area 440 between drill pipe 418 and the sides of borehole 412. The drilling fluid may then be returned to the mud pit 434, for example via pipe 437, and the fluid is filtered. The drilling fluid cools drill bit 426, as well as provides for lubrication of drill bit 426 during the drilling operation. Additionally, the drilling fluid removes the cuttings of subsurface formations 414 created by drill bit 426.

Still referring to FIG. 4A, a plurality of optical computing devices 442 as described herein are positioned along the drill string. Downhole tool 424 may also include any number of sensors which monitor different downhole parameters and generate data that is stored within one or more different storage mediums within the downhole tool 424. Alternatively, however, the data may be transmitted to a remote location (e.g., surface) and processed accordingly. Such parameters may include logging data related to the various characteristics of the subsurface formations (such as resistivity, radiation, density, porosity, etc.) and/or the characteristics of the borehole (e.g., size, shape, etc.), etc.

FIG. 4A also illustrates an alternative embodiment in which a wireline system is deployed. In such an embodiment, the wireline system may include a downhole tool body 471 coupled to a base 476 by a logging cable 474. Logging cable 474 may include, but is not limited to, a wireline (multiple power and communication lines), a mono-cable (a single conductor), and a slick-line (no conductors for power or communications). Base 476 is positioned above ground and optionally includes support devices, communication devices, and computing devices. Tool body 471 houses any one of the optical computing devices 472 described herein. In an embodiment, a power source (not shown) is positioned in tool body 471 to provide power to the tool 471. In operation, the wireline system is typically sent downhole after the completion of a portion of the drilling. More specifically, in certain methods, drill string 408 creates borehole 412, then drill string 408 is removed, and the wireline system is inserted into borehole 412. Note that only one borehole is shown for simplicity in order to show the tools deployed in drilling and wireline applications. In certain applications, multiple boreholes would be drilled as understood in the art.

FIG. 4B is a production system 510, according to certain illustrative applications of the present disclosure. In the production system 510, a tubular production string 512 is installed in a wellbore 514, and fluid 516 is produced (via an interior 524 of the production string) to a surface location 518 from an earth formation 520 intersected by the wellbore. The surface location 518 can be a land-based, subsea, floating, mudline or other location which is proximate the earth's surface. A wellhead and/or production facility may be disposed at the surface location 518.

Wellbore 514 is depicted in FIG. 4B as being generally vertical, and as being lined with casing 522. However, in other examples, wellbore 514 could be uncased or open hole, the wellbore could be generally horizontal, inclined relative to vertical, etc. Although fluid 516 is depicted as entering a lower end of production string 512 from one location, in other examples the production string could have one or more valves or other flow control devices for admitting the fluid into the interior 524 of the production string, the fluid could be admitted into the interior of the production string at multiple locations or zones, etc. Production packers 528 serve as a pressure barrier to prevent the flow of fluid 516 to the surface via annulus 526. Thus, it should be clearly understood that the well production system 510 is described herein and is illustrated in the drawings as merely one example of how the principles of this disclosure can be beneficially utilized, but those principles are not limited in any way to the details of the well system 510. Instead, the principles of this disclosure can be applied to a wide variety of different well systems.

In this embodiment, one of more optical computing devices 532 as defined herein are positioned along sidewall 530 of production string 512. During operations, fluid 516 is produced from the formation 520 and flows via the interior 524 of production string 512 to surface location 518. As fluid 516 flows past optical computing devices 532, the fluid may be analyzed accordingly.

In these particular applications, optical devices 442,472,532 are optical computing devices forming part of a reservoir interrogation tool. In general, an optical computing device is a device configured to receive an input of electromagnetic radiation from a sample and produce an output of electromagnetic radiation from a processing element, also referred to as an optical element, wherein the output reflects the measured intensity of the electromagnetic radiation. The optical computing device may be, for example, an ICE. One type of an ICE is an optical thin film optical interference device, also known as a multivariate optical element (“MOE”).

Fundamentally, optical computing devices utilize optical elements to perform calculations, as opposed to the hardwired circuits of conventional electronic processors. When light from a light source interacts with a substance, unique physical and chemical information about the substance is encoded in the electromagnetic radiation that is reflected from, transmitted through, or radiated from the sample. The ICE is configured to be associated with a particular characteristic of the sample or may be designed to approximate or mimic the regression vector of the characteristic in a desired manner. Thus, the optical computing device, through use of the ICE and one or more detectors, is capable of extracting the information of one or multiple characteristics/analytes within a substance and converting that information into a detectable output signal reflecting the overall properties of a sample. Such characteristics may include, for example, the presence of certain elements, compositions, fluid phases, etc. existing within the substance.

Referring still to FIGS. 4A and 4B, one or more optical computing devices 442,472,532 may be positioned along the wellbore at any desired location. In certain embodiments, optical computing devices 442,472,532 may be permanently or removably attached to the tubulars and distributed throughout the wellbore in any area in which sample characteristic detection is desired. Optical computing devices 442,472,532 may be coupled to a remote power supply (located on the surface or a power generator positioned downhole along the wellbore, for example), while in other embodiments each optical computing device 442,472,532 comprises an on-board battery. Moreover, optical computing devices 442,472,532 are communicably coupled to a processing circuitry (e.g., a CPU station) (not shown) via a communications link, such as, for example, a wireline, inductive coupling or other suitable communications link.

As mentioned above, each optical computing device 442,472,532 may comprise one or more ICEs. Alternatively, as with earlier discussed embodiments, no ICE is included in other embodiments. In those embodiments using ICEs, optical computing devices 442,472,532 may determine the presence and quantity of specific gases, fluids, components and properties relevant to hydrocarbon exploration and production such as, for example, CO₂, H₂S, methane (C1), ethane (C2) and propane (C3), saline water, dissolved ions (Ba, Cl, Na, Fe, or Sr, for example) or various other characteristics (p.H., density and specific gravity, viscosity, total dissolved solids, sand content, etc.). Furthermore, the presence of formation characteristic data (viscosity, phase, formation chemical composition, etc.) may also be determined.

The CPU station comprises a signal processor (not shown), communications module (not shown) and other circuitry necessary to achieve the objectives of the present disclosure. In addition, it will also be recognized that the software instructions necessary to carry out the objectives of the present disclosure may be stored within storage located in the CPU station or loaded into that storage from a CD-ROM or other appropriate storage media via wired or wireless methods. The communications link provides a medium of communication between the CPU station and optical computing devices 442,472,532. The communications link may be a wired link, such as, for example, a wireline or fiber optic cable extending down into a vertical wellbore. Alternatively, however, the communications link may be a wireless link, such as, for example, an electromagnetic device of suitable frequency, or other methods including acoustic communication, mud pulse telemetry, or other downhole communication/telemetry systems.

In certain illustrative embodiments, the CPU station, via its signal processor, controls operation of each optical computing device 442,472,532. In addition to sensing operations, the CPU station may also control activation and deactivation of the optical window cleaning systems on-board devices 442,472,532. Optical computing devices 442,472,532 each include a transmitter and receiver (transceiver, for example) (not shown) that allows bi-directional communication over the communications link in real-time. In certain illustrative embodiments, optical computing devices 442,472,532 will transmit all or a portion of the sample characteristic data to the CPU station for further analysis. However, in other embodiments, such analysis is partially or completely handled by each optical computing device 442,472,532 and the resulting data is then transmitted to the CPU station for storage or subsequent analysis. In either embodiment, the processor handling the computations analyzes the characteristic data and, through utilization of Equation of State (“EOS”) or other multivariate optical analysis techniques, derives the desired sample characteristic indicated by the transmitted data.

After deployment of optical computing devices 442,472,532, downhole fluids may be monitored as desired. Once the isolation windows contained within devices 442,472,532 begin to accumulate debris, the optical cleaning system may be activated as described herein. Accordingly, the integrity of the optical device is maintained.

As previously described, the window cleaning systems discussed herein may be utilized in a variety of optical devices. One such device is a pipeline optical window or some other inspection window device used for visual inspection of fluids flowing therethrough. Such optical devices allow operators to look into a system to determine, for example, if the system is fluid filled, if bubbles are present in the fluid, or if the fluid is the right color. In such a system, ambient light may serve as the electromagnetic radiation, the isolation window itself would be the pipeline optical window, and no detector is necessary.

Accordingly, the illustrative embodiments described herein provide methods by which to clean isolation windows without the need for dissembling the device. By suspending abrasive particles in a solution, and delivering it to the windows whereby a moveable magnetic field causes the particles to clean the window, a low cost solution for cleaning the windows is provided. Thus, the windows may be cleaned in the field after use, or at least between window servicing events like replacing o-ring seals. Accordingly, the embodiments described herein would reduce tool downtime greatly. Moreover, by utilizing water as the suspension fluid, the present disclosure provides a “green” cleaning method, thus eliminating chemical waste and reducing chemical handling risks.

Embodiments described herein further relate to any one or more of the following paragraphs:

1. An optical device window cleaning system, comprising at least one isolation window having a first and second surface, the isolation window being positioned to allow electromagnetic radiation to interrogate a sample on the first surface; a suspension of abrasive particles disposed in the sample; and a magnetic field positioned to deposit the abrasive particles on the first surface of the isolation window, the magnetic field being moveable such that the abrasive particles move about the first surface of the isolation window.

2. An optical device window cleaning system as defined in paragraph 1, wherein the abrasive particles are ferrous particles; and the system further comprises a moveable magnet positioned adjacent the second surface of the isolation window, thereby generating the magnetic field.

3. An optical device window cleaning system as defined in paragraphs 1 or 2, wherein the abrasive particles are magnetic particles, thereby generating the magnetic field; and the system further comprises a moveable ferrous member positioned adjacent the second surface of the isolation window.

4. An optical device window cleaning system as defined in any of paragraphs 1-3, further comprising a mechanism to move the magnet or ferrous member about the second surface of the isolation window.

5. An optical device window cleaning system as defined in any of paragraphs 1-4, wherein the abrasive particles are ferrous particles; and the system further comprises electromagnetic coils positioned adjacent the second surface of the isolation window, thereby generating the magnetic field.

6. An optical device window cleaning system as defined in any of paragraphs 1-5, wherein the cleaning system comprises part of an Integrated Computational Element-based optical computing system.

7. An optical device window cleaning system as defined in any of paragraphs 1-6, wherein the cleaning system comprises part of a downhole reservoir interrogation tool.

8. An optical device window cleaning system as defined in any of paragraphs 1-7, wherein the cleaning system comprises part of a visual inspection window device.

9. A method for cleaning an optical device window, comprising generating a magnetic field adjacent an isolation window having a first and second surface, the isolation window being positioned to allow electromagnetic radiation to interrogate a sample comprising a suspension of abrasive particles; delivering the abrasive particles to the first surface of the isolation window using the magnetic field; and moving the magnetic field such that the abrasive particles are moved about the first surface, thereby cleaning the isolation window.

10. A method as defined in paragraph 9, wherein the magnetic field is moved by moving a magnet positioned adjacent the second surface of the isolation window.

11. A method as defined in paragraphs 9 or 10, wherein the magnetic field is moved by moving a ferrous member positioned adjacent the second surface of the isolation window.

12. A method as defined in any of paragraphs 9-11, wherein moving the magnet or ferrous member comprises at least one of rotating a rod along the second surface of the isolation window; or oscillating the rod along the second surface of the isolation window.

13. A method as defined in any of paragraphs 9-12, wherein the magnetic field is moved using a coil assembly positioned adjacent the second surface of the isolation window.

14. A method as defined in any of paragraphs 9-13, further comprising selectively activating coils of the coil assembly to move the magnetic field.

15. A method as defined in any of paragraphs 9-14, further comprising utilizing optical measurement data to determine a cleanliness of the isolation window.

16. A method as defined in any of paragraphs 9-15, wherein the measurement data comprises at least one of a voltage output of the optical device over time; or spectral output of the optical device over time.

17. A method as defined in any of paragraphs 9-16, wherein the optical measurement data is utilized to activate and deactivate the magnetic field.

18. A method as defined in any of paragraphs 9-17, wherein the abrasive particles are magnetic; and the method further comprises demagnetizing the abrasive particles after cleaning the isolation window.

19. A method as defined in any of paragraphs 9-18, wherein the demagnetization is achieved by heating the abrasive particles through manipulation of the magnetic field.

20. A method as defined in any of paragraphs 9-19, further comprising utilizing optical measurement data to determine if a sufficient number of abrasive particles have accumulated on the first surface of the isolation window.

21. A method as defined in any of paragraphs 9-20, wherein the method is utilized to clean the isolation window of an optical device deployed in a downhole environment.

22. A method as defined in any of paragraphs 9-21, wherein the method is utilized to clean the isolation window of a visual inspection window device.

23. An optical device window cleaning system, comprising at least one isolation window having a first and second surface, the isolation window being positioned to allow electromagnetic radiation to interrogate a sample on the first surface; and a moveable magnetic field positioned adjacent the isolation window.

24. An optical device window cleaning system as defined in paragraph 23, further comprising a moveable magnet positioned adjacent the second surface of the isolation window, thereby generating the magnetic field.

25. An optical device window cleaning system as defined in paragraphs 23 or 24, further comprising a moveable ferrous member positioned adjacent the second surface of the isolation window.

26. An optical device window cleaning system as defined in any of paragraphs 23-25, further comprising a mechanism to move the magnet or ferrous member about the second surface of the isolation window.

27. An optical device window cleaning system as defined in any of paragraphs 23-26, further comprising electromagnetic coils positioned adjacent the second surface of the isolation window, thereby generating the magnetic field.

28. An optical device window cleaning system as defined in any of paragraphs 23-27, wherein the cleaning system comprises part of an Integrated Computational Element-based optical computing system.

29. An optical device window cleaning system as defined in any of paragraphs 23-28, wherein the cleaning system comprises part of a downhole reservoir interrogation tool.

30. An optical device window cleaning system as defined in any of paragraphs 23-29, wherein the cleaning system comprises part of a visual inspection window device.

Although various embodiments and methods have been shown and described, this disclosure is not limited to such embodiments and methods, and will be understood to include all modifications and variations as would be apparent to one ordinarily skilled in the art. Therefore, it should be understood that the embodiments are not intended to be limited to the particular forms disclosed. Rather, the intention is to cover all modifications, equivalents and alternatives falling within the spirit and scope of this disclosure as defined by the appended claims.

1. An optical device window cleaning system, comprising:
at least one isolation window having a first and second surface, the isolation window being positioned to allow electromagnetic radiation to interrogate a sample on the first surface;
a suspension of abrasive particles disposed in the sample; and
a magnetic field positioned to deposit the abrasive particles on the first surface of the isolation window, the magnetic field being moveable such that the abrasive particles move about the first surface of the isolation window.

2. An optical device window cleaning system as defined in claim 1, wherein:
the abrasive particles are ferrous particles; and
the system further comprises a moveable magnet positioned adjacent the second surface of the isolation window, thereby generating the magnetic field.

3. An optical device window cleaning system as defined in claim 1, wherein:
the abrasive particles are magnetic particles, thereby generating the magnetic field; and
the system further comprises a moveable ferrous member positioned adjacent the second surface of the isolation window.

4. An optical device window cleaning system as defined in claim 2, further comprising a mechanism to move the magnet or ferrous member about the second surface of the isolation window.

5. An optical device window cleaning system as defined in claim 1, wherein:
the abrasive particles are ferrous particles; and
the system further comprises electromagnetic coils positioned adjacent the second surface of the isolation window, thereby generating the magnetic field.

6. An optical device window cleaning system as defined in claim 1, wherein the cleaning system comprises part of an Integrated Computational Element-based optical computing system.

7. An optical device window cleaning system as defined in claim 1, wherein the cleaning system comprises part of a downhole reservoir interrogation tool.

8. An optical device window cleaning system as defined in claim 1, wherein the cleaning system comprises part of a visual inspection window device.

9. A method for cleaning an optical device window, comprising:
generating a magnetic field adjacent an isolation window having a first and second surface, the isolation window being positioned to allow electromagnetic radiation to interrogate a sample comprising a suspension of abrasive particles;
delivering the abrasive particles to the first surface of the isolation window using the magnetic field; and
moving the magnetic field such that the abrasive particles are moved about the first surface, thereby cleaning the isolation window.

10. A method as defined in claim 9, wherein the magnetic field is moved by moving a magnet positioned adjacent the second surface of the isolation window.

11. A method as defined in claim 9, wherein the magnetic field is moved by moving a ferrous member positioned adjacent the second surface of the isolation window.

12. A method as defined in claim 10, wherein moving the magnet or ferrous member comprises at least one of:
rotating a rod along the second surface of the isolation window; or
oscillating the rod along the second surface of the isolation window.

13. A method as defined in claim 9, wherein the magnetic field is moved using a coil assembly positioned adjacent the second surface of the isolation window.

14. A method as defined in claim 13, further comprising selectively activating coils of the coil assembly to move the magnetic field.

15. A method as defined in claim 9, further comprising utilizing optical measurement data to determine a cleanliness of the isolation window.

16. A method as defined in claim 15, wherein the measurement data comprises at least one of:
a voltage output of the optical device over time; or
spectral output of the optical device over time.

17. A method as defined in claim 15, wherein the optical measurement data is utilized to activate and deactivate the magnetic field.

18. A method as defined in claim 9, wherein:
the abrasive particles are magnetic; and
the method further comprises demagnetizing the abrasive particles after cleaning the isolation window.

19. A method as defined in claim 18, wherein the demagnetization is achieved by heating the abrasive particles through manipulation of the magnetic field.

20. A method as defined in claim 9, further comprising utilizing optical measurement data to determine if a sufficient number of abrasive particles have accumulated on the first surface of the isolation window.

21. A method as defined in claim 9, wherein the method is utilized to clean the isolation window of an optical device deployed in a downhole environment.

22. A method as defined in claim 9, wherein the method is utilized to clean the isolation window of a visual inspection window device.

23. An optical device window cleaning system, comprising:
at least one isolation window having a first and second surface, the isolation window being positioned to allow electromagnetic radiation to interrogate a sample on the first surface; and
a moveable magnetic field positioned adjacent the isolation window.

24. An optical device window cleaning system as defined in claim 23, further comprising a moveable magnet positioned adjacent the second surface of the isolation window, thereby generating the magnetic field.

25. An optical device window cleaning system as defined in claim 23, further comprising a moveable ferrous member positioned adjacent the second surface of the isolation window.

26. An optical device window cleaning system as defined in claim 24, further comprising a mechanism to move the magnet or ferrous member about the second surface of the isolation window.

27. An optical device window cleaning system as defined in claim 23, further comprising electromagnetic coils positioned adjacent the second surface of the isolation window, thereby generating the magnetic field.

28. An optical device window cleaning system as defined in claim 23, wherein the cleaning system comprises part of an Integrated Computational Element-based optical computing system.

29. An optical device window cleaning system as defined in claim 23, wherein the cleaning system comprises part of a downhole reservoir interrogation tool.

30. An optical device window cleaning system as defined in claim 23, wherein the cleaning system comprises part of a visual inspection window device.
